(19) United States
(12) Patent Application Publication
(10) Pub. No.: US 2004/0186876 A1
(43) Pub. Date: Sep. 23, 2004

(54) Processor system operable in a supervisor mode and a user mode

(75) Inventor: Klaus Brandstatter, Rosstal (DE)

Correspondence Address: BROWDY AND NEIMARK, P.L.L.C., 624 NINTH STREET, NW, SUITE 300, WASHINGTON, DC, 20001-5303, US

(73) Assignee: HOB electronic GmbH & CO. KG, Cadolzburg (DE)

(21) Appl. No.: 10/389,746

(22) Filed: Mar. 18, 2003

(51) Int. Cl. G06F 17/00

(52) U.S. Cl. 709/200

(57) ABSTRACT

A processor system operable in a supervisor mode and a user mode comprises a main processor, an ancillary processor, a virtual machine operating system implemented on said main processor and ancillary processor and comprising operating systems for said main processor and for said ancillary processor, at least one guest operating system running on said virtual machine operating system and at least one application program running on said at least one guest operating system including supervisor mode instructions and user mode instructions, wherein said virtual machine operating system is adapted to execute user mode instructions in said user mode of the at least one guest operating system directly on said ancillary processor and to emulate supervisor mode instructions and user mode instructions in said supervisor mode of the at least one guest operating system on said main processor.

### BACKGROUND OF THE INVENTION

1. Field of the Invention

The invention relates to a processor system operable in a supervisor mode and a user mode, said supervisor mode comprising a set of supervisor mode instructions and said user mode comprising a set of user mode instructions.

2. Background Art

Electronic data processing systems typically include an operating system which is implemented on the hardware of the system. Software programs to be executed on the data processing system are enabled by this operating system to access the installed hardware components, like the central processing unit, its working memory, data memory, I/O-components and the like.

For several reasons there may be the need to implement several operating systems—so-called guest operating systems—which are independent from each other on the same processor system, e.g. to fully exploit a high performance processor system or to take care for a strict logical separation of user groups with varying software requirements.

To comply with such conditions the prior art knows so-called virtual machine operating systems which provide a data and processor ambience for each guest operating system. This environment is the virtual machine on which the guest operating system can act as if it is directly implemented on a certain hardware platform which it solely controls. The virtual machine operating system is responsible for a co-ordination of the hardware access requirements of the guest operating systems to realize the access in a useful and safe way. Furtheron the virtual machine operating system serves for the data exchange between the hardware components and the guest operating systems. Inasmuch the virtual machine operating system makes sure that a hardware access requirement from a first guest operating system does not interfere with another access requirement from a second guest operating system. Furtheron the virtual machine operating system checks whether or not an access requirement of a guest operation system is admissible, i.e. whether the guest operating system is allowed to work with a particular hardware component of the processor and whether the required hardware access is safe within the rules defined for such an access. After these checks the virtual machine operating system transmits the access requirement to the real hardware.

A further aspect as concerns the background of the invention are certain operation modes in which processors execute commands. One is the so-called supervisor mode which allows the execution of all commands known to the processor, especially those commands, which allow an access to the system on the hardware level. There are the operating system and the programs associated to the operating system which run in the supervisor mode. Inasmuch the supervisor mode allows the execution of so-called privileged commands which amongst others are responsible for highly critical hardware accesses.

The second mode is the so-called user mode in which contrary to the supervisor mode instructions a restricted set of user mode instructions are admissible in which set the execution of the privileged commands is forbidden. Inasmuch usual application programs always run in the user mode.

Another aspect concerning the background of the invention refers to various kinds of processor architecture. Usually a certain processor is provided with and adapted to a defined set of instructions which is optimized for the processor architecture. Now to ensure compatibility to given software solutions certain processors are able to execute instructions both of its own particular instruction set and of another instruction set belonging to a different kind of processor. To realize such double functionality in such a kind of processor two sub-processors are integrated which are usually a main processor for the first type of instruction set and an ancillary processor for the second type of instruction set.

Now in case a software program is to be executed which is designated for the ancillary processor then the operating system switches from the main processor to the ancillary processor on which the required commands are executed.

In case a virtual machine operating system is implemented on a processor system using aforesaid architecture and an operating system which is associated to the ancillary processor there are usually two methods of processing the instructions a guest operating system has to execute. One method is to execute the instructions directly on the ancillary processor. The other method is to emulate the instructions on the main processor.

The advantage of the former method is the substantially higher speed of execution. However, there is no possibility to check the results and consequences of the instructions. Inasmuch especially in connection with privileged instructions which are executed on the hardware level errors may arise which have disastrous consequences.

Vice versa the execution rate of instructions which are emulated is arbitrarily lower compared to a direct execution on hardware level. However the effects of the instructions can thoroughly be checked during the emulation process ensuring the safe and undisturbed run of a certain program.

### SUMMARY OF THE INVENTION

It is an object of the invention to provide for a processor system implementing a virtual machine operating system which according to the characteristics of the instructions to be run selectively enhances the execution rate and the safety of the program run.

According to the invention this object is achieved by a processor system operable in a supervisor mode and a user mode, said supervisor mode comprising a set of supervisor mode instructions and said user mode comprising a set of user mode instructions, said microprocessor system comprising a main processor, an ancillary processor, a virtual machine operating system implemented on said main processor and ancillary processor and comprising operating systems for said main processor and for said ancillary processor, at least one guest operating system running on said virtual machine operating system and at least one application program running on said at least one guest operating system including supervisor mode instructions and user mode instructions, wherein said virtual machine operating system is adapted to execute user mode instructions in said user mode of the at least one guest operating system directly on said ancillary processor and to emulate supervisor mode instructions and user mode instructions in said supervisor mode of the at least one guest operating system on said main processor.

As can readily be seen the virtual machine operating system due to the characteristics of the instructions to be run switches between on the one hand a direct execution on the ancillary processor when executing uncritical user mode instructions and on the other hand an emulation of more critical instructions when running a program on the at least one guest operating system in the supervisor mode. Accordingly this kind of processor system combines the advantages of directly running a program on hardware level in a fast manner and an emulation of critical operations to enhance safety. In this connection the loss of execution rate due to the emulation of the instructions in the supervisor mode is not too critical as only a small part of the steps, commands and instructions run by a program are used in the supervisor mode.

According to preferred embodiments of the invention the user mode instructions are directly executed on the ancillary processor without monitoring effects of the user mode instructions to the processor system on the one hand and the supervisor mode instructions during emulation on the main processor are monitored as concerns their effect to the processor system on the other hand.

According to a further aspect of the invention the main processor comprises a bit width which is larger than the bit width of the ancillary processor. Inasmuch the main processor has a higher performance than the ancillary processor what helps to balance out the negative influence of the emulation in the supervisor mode as concerns the execution rate.

### BRIEF DESCRIPTION OF THE DRAWINGS

Further features, details and advantages of the invention will become apparent from the ensuing description of an exemplary embodiment taken in conjunction with the drawings, in which

FIG. 1 is a block diagram of a processor system and

FIG. 2 is a combined block diagram and time chart reflecting a program run on the processor system according to FIG. 1.

### DESCRIPTION OF THE PREFERRED EMBODIMENT

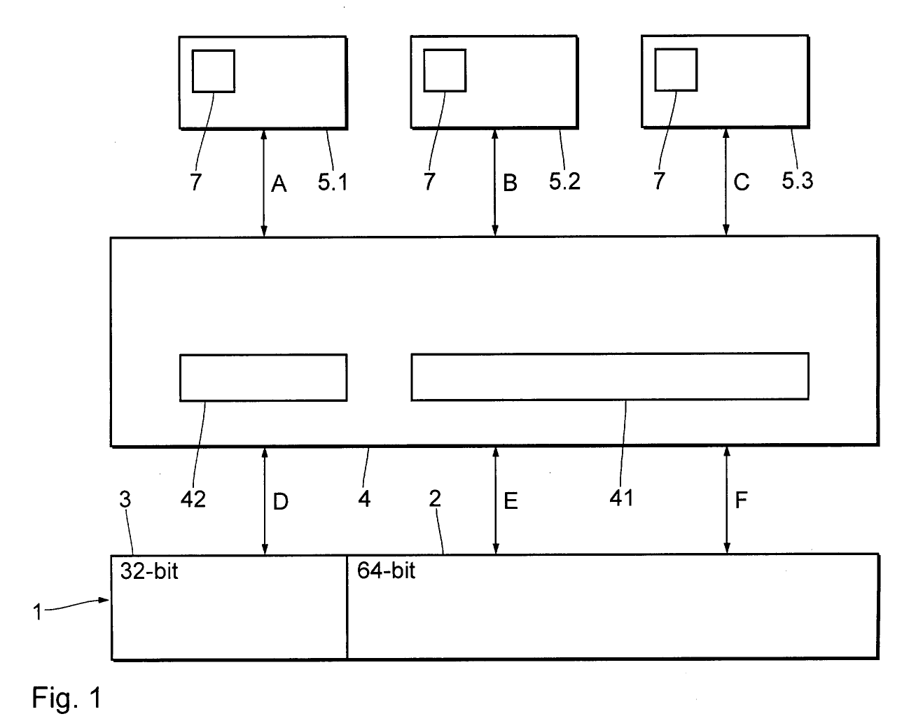

Referring to FIG. 1 the virtual machine concept in general is to be explained. Accordingly a hardware 1 of the processor system comprises a main processor 2 and an ancillary processor 3. In practice the main processor 2 may be an Itanium® processor which has a bit width of 64 bit. The ancillary processor 3 may be represented by a 32 bit Pentium® processor. Both aforesaid processor types are produced and distributed by INTEL Corp., Santa Clara, Calif.

On this hardware 1 a virtual machine operating system 4 is installed which comprises operating systems 41, 42 for the main processor 2 and the ancillary processor 3 and which serves as basis for several guest operating systems 5.1, 5.2, 5.3. The virtual machine operating system in this connection creates an environment for each guest operating system 5 in which the latters act as if they had direct and exclusive access to the hardware 1. During execution of programs on each guest operating system the virtual machine operating system ensures that any hardware access from one of the guest operating systems 5.1, 5.2, 5.3 does not interfere with any access from another guest operating system 5.1, 5.2, 5.3. Furtheron the virtual machine operating system checks whether or not the access, instruction or command required by any guest operating system 5.1, 5.2, 5.3 is safe within certain rules defined for such an access, command or instruction (indicated by arrows A, B, C in FIG. 1). Finally the vertical machine operating system checks whether or not the respective guest operating system 5.1, 5.2, 5.3 is allowed to work with a particular hardware component. After that the virtual machine operating system enables the access to the hardware 1 and enables the required command or instruction (indicated by arrows D, E, F in FIG. 1).

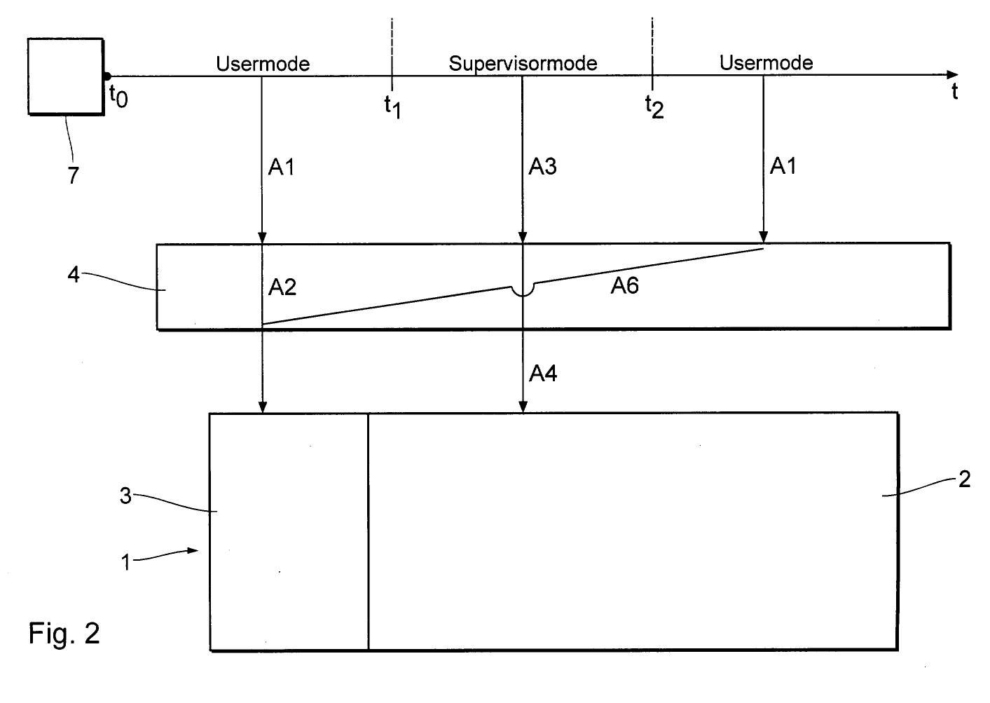

Now referring to FIG. 2 this drawing again reflects the hardware 1 with its main processor 2 and ancillary processor 3. Furtheron the vertical machine operating system 4 is again installed on this processor hardware 1. Above this block diagram as a kind of time chart a half line 6 represents the time history t of a program 7 running on one (e.g. 5.1) of the guest operating systems 5.1, 5.2, 5.3 (FIG. 1).

During a first period between times t₀ and t₁ the program 7 runs in the user mode. The according user mode instructions are passed over (arrow A1) from the guest operating system 5.1 to the virtual machine operating system 4 which checks the mode characteristic of the program 7 at that time. Confirming the program 7 is running in the user mode the virtual machine operating system 4 directly passes over (arrow A2) the user mode instructions onto ancillary processor 3 where these instructions are directly executed without monitoring any effects of the user mode instructions to the microprocessor system.

In the period between times t₁ and t₂ the program 7 switches over to the supervisor mode and again passes its instructions over to the virtual machine operating system 4 (arrow A3). The latter verifies that program 7 is running in the supervisor mode and therefore passes over the supervisor mode instructions to the main processor 2 (arrow A4) on which these instructions are not executed directly on the hardware but are emulated and monitored as concerns there effects to the hardware 1 of the processor system.

At time t₂ the program 7 shifts back to the user mode what is verified by the virtual machine operating system 4 again (arrow A6). The latter accordingly passes over the user mode instructions to the ancillary processor 3 on which they run directly on hardware level.

What is claimed is

1st A processor system operable in a supervisor mode and a user mode, said supervisor mode comprising a set of supervisor mode instructions and said user mode comprising a set of user mode instructions, said processor system comprising
a main processor (2),
an ancillary processor (3),
a virtual machine operating system (4) implemented on said main processor (2) and ancillary processor (3) and comprising operating systems for said main processor (2) and for said ancillary processor (3),
at least one guest operating system (5) running on said virtual machine operating system (4) and
at least one application program (7) running on said at least one guest operating system (5) including supervisor mode instructions and user mode instructions,
wherein said virtual machine operating system (4) is adapted to execute user mode instructions in said user mode of the at least one guest operating system (5) directly on said ancillary processor (3) and to emulate supervisor mode instructions and user mode instructions in said supervisor mode of the at least one guest operating system (5) on said main processor (2).

2nd A microprocessor system according to claim 1, wherein the user mode instructions are directly executed on the ancillary processor (3) without monitoring effects of the user mode instructions to the processor system.

3rd A microprocessor system according to claim 1, wherein the supervisor mode instructions during emulation on the main processor (3) are monitored as concerns their effects to the processor system.

4th A microprocessor system according to claim 1, wherein the main processor (2) comprises a bit width which is larger than the bit width of the ancillary processor (3).
